(19) United States
(12) Patent Application Publication
(10) Pub. No.: US 2024/0011162 A1
(43) Pub. Date: Jan. 11, 2024

(54) TREATMENT OF METALLIC SURFACES BY COPOLYMER CONTAINING ACIDIC AQUEOUS COMPOSITIONS

(71) Applicant: CHEMETALL GMBH, Frankfurt (DE)

(72) Inventors: Nawel Souad KHELFALLAH, Frankfurt (DE); Thomas BURKHARDT, Frankfurt (DE); Ilya OSTROVSKY, Frankfurt (DE); Manfred WALTER, Frankfurt (DE); Sven Daniel GASPARIC, Frankfurt (DE); Helen ROTHER-NOEDING, Ludwigshafen (DE)

(21) Appl. No.: 18/251,614

(22) PCT Filed: Nov. 9, 2021
(86) PCT No.: PCT/EP2021/081096

§ 371 Date: May 3, 2023

(30) Foreign Application Priority Data
Nov. 10, 2020 (EP) 20206678.3

(51) Int. Cl. C23C 22/34

(52) U.S. Cl. CPC C23C 22/34

(57) ABSTRACT

Disclosed herein is a method for treatment of at least one metallic surface of a substrate including at least a step of contacting said surface with an acidic aqueous composition (A), said acidic aqueous composition (A) including (a) one or more metal ions selected from the group consisting of titanium, zirconium and hafnium ions (b) and one or more polymers (P) containing OH- and/or COOH-groups as well as at least one sulfur-containing moiety, to a corresponding acidic aqueous composition (A) as such, a master batch to produce such acidic aqueous composition (A), the use of the acidic aqueous composition (A) for treating metallic surfaces and substrates including the thus treated surfaces.

The present invention relates to a method for treatment of at least one metallic surface of a substrate comprising at least a step of contacting said surface with an acidic aqueous composition (A), said acidic aqueous composition (A) comprising (a) one or more metal ions selected from the group of titanium, zirconium and hafnium ions (b) and one or more polymers (P) containing OH- and/or COOH-groups as well as at least one sulfur-containing moiety, to a corresponding acidic aqueous composition (A) as such, to a master batch to produce such acidic aqueous composition (A), to the use of the acidic aqueous composition (A) for treating metallic surfaces and to substrates comprising the thus treated surfaces.

### BACKGROUND OF THE INVENTION

Aluminum materials made from aluminum and/or an aluminum alloy are typically subjected to an anti-corrosive and adhesion-promoting pretreatment method. Said pretreatment method is generally preceded by pickling the aluminum material. Such pretreatment of aluminum materials is e.g. used for architectural construction elements made of aluminum and/or aluminum alloys in various indoor and outdoor areas, but also e.g. for vehicle parts made of aluminum and/or an aluminum alloy such as wheels. After said pretreatment, usually further coatings are applied to the pretreated aluminum materials.

WO 2010/100187 A1 discloses a two-step method for treatment of metallic surfaces such as surfaces made of aluminum or an aluminum alloy. In a first step the surface is contacted with an aqueous composition containing a silane/silanol/(poly)siloxane. In a subsequent second step the surface is contacted with an aqueous composition containing a phosphonic compound such as a phosphonate/phosphonic acid. Thus, a (poly)siloxane and a phosphonate coating are being successively formed. Such conventional two-step methods in general involve comparably great expenses due to an increased expenditure of time, energy and labor and are therefore disadvantageous.

Conventional aqueous solutions for use in a pretreatment method of aluminum materials are based on complex fluorides such as titanium and/or zirconium complex fluorides in order to form a conversion coating on their surfaces before any further coatings are applied. Subsequently, a further aqueous solution comprising phosphonate compounds may be applied afterwards such that the pretreatment is carried out in form a two-step method. However, the use of such two-step-methods is disadvantageous for the reasons outlined above. Alternatively, the aqueous solutions based on complex fluorides may additionally contain phosphonate compounds such that the pretreatment is performed in total in form of a one-step method. However, the use of phosphonates is undesired for ecological reasons as phosphonates are regarded as contaminants. Due to wastewater regulations and the requirement to purify the wastewater accordingly this is also disadvantageous from an economical view.

The presently known one-step pretreatment methods with complex fluorides such as titanium and/or zirconium complex fluorides, however, do not always deliver satisfying results with respect to a sufficient corrosion protection, in particular regarding the undesired occurrence of filiform corrosion, and/or with respect to sufficient adhesion properties.

For example, in U.S. Pat. No. 4,921,552 a method for coating of aluminum materials or alloys thereof is disclosed. The coating composition used for this purpose inter alia contains a polyacrylic acid polymer and H₂ZrF₆. In U.S. Pat. No. 4,191,596 a further method for coating of aluminum materials or alloys thereof is disclosed. The coating composition used for this purpose inter alia contains a polyacrylic acid polymer or an ester thereof and at least one of H₂TiF₆, H₂ZrF₆, and H₂SiF₆. In addition, WO 97/13588 A1 discloses a method for coating the surface of a metal selected from aluminum and aluminum alloys, which method comprises a step of contacting the surface with an aqueous acid solution containing at least one of H₂TiF₆, H₂ZrF₆, HBF₄ and H₂SiF₆. After a step of rinsing the surface is then further coated with an aqueous polymeric composition. Further, WO 2017/046139 A1 discloses a method for a pretreatment of inter alia workpieces having a surface of aluminum or aluminum alloys, wherein the method inter alia comprises a step of applying an aqueous acidic and chromium-free solution to the workpieces, the solution comprising Zr as complex fluoride, and Mo as molybdate.

Further, WO 2020/049132 A1, WO 2020/049134 A1 and WO 2019/053023 A1 each relates to a method for treatment of at least one surface of a substrate, wherein said surface is at least partially made of aluminum and/or an aluminum alloy. Each of the methods comprises a step of contacting the surface with an aqueous composition, which contains at least one linear polymer containing inter alia phosphonic acid groups.

Thus, there is a need to provide a method for treatment of metallic substrates, in particular at least partially made of aluminum and/or an aluminum alloy, which methods allows formation of a single conversion coating layer in a single step, is both economically and ecologically advantageous, and which provides good anti-corrosion properties as well as no disadvantages with respect to adhesion properties when applying further coatings onto the formed conversion coating layer.

### Problem

It has been therefore an object underlying the present invention to provide a method for treatment of metallic substrates, in particular at least partially made of aluminum and/or an aluminum alloy, which methods allows formation of a single conversion coating layer in a single step, and in particular allows avoiding of conventionally used phosphonate treatment steps, is both economically and ecologically advantageous, and which provides good anti-corrosion properties as well as no disadvantages with respect to adhesion properties when applying further coatings onto the formed conversion coating layer.

### Solution

This object has been solved by the subject-matter of the claims of the present application as well as by the preferred embodiments thereof disclosed in this specification, i.e. by the subject matter described herein.

A first subject-matter of the present invention is a method for treatment of at least one surface of a substrate, wherein said surface is at least partially made of at least one metal, in particular at least partially made of aluminum and/or an aluminum alloy, comprising at least a step (1), namely
(1) contacting the at least one surface of the substrate with an acidic aqueous composition (A), wherein the acidic aqueous composition (A) comprises
   (a) at least one metal ion selected from the group of titanium, zirconium, hafnium ions and mixtures thereof, and
   (b) at least one polymer (P), wherein the polymer (P) is a copolymer obtained from at least two different ethylenically unsaturated monomers, and wherein the polymer (P) comprises at least two kinds of side chains (S1) and (S2), which are different from each other, wherein side chain (S1) comprises at least one functional group selected from the group consisting of hydroxyl groups and carboxylic acid groups and mixtures thereof, and side chain (S2) comprises at least one sulfur-containing moiety, which is preferably selected from the group consisting of thiol groups, thioether groups, thioester groups, thiocarboxylic acid groups and mixtures thereof.

By contacting step (1) a conversion coating film is formed on the surface of the substrate.

A further subject-matter of the present invention is an acidic aqueous composition (A), said acidic aqueous composition (A) being the one used in the above defined contacting step of the inventive method.

A further subject-matter of the present invention is a master batch to produce the inventive acidic aqueous composition (A) by diluting the master batch with water and if applicable by adjusting the pH value.

A further subject-matter of the present invention is a use of the inventive acidic aqueous composition (A) for treating at least one surface of a substrate, wherein said surface is at least partially made of at least one metal, preferably at least partially made of aluminum and/or an aluminum alloy, preferably to provide corrosion protection to the surface and/or to the substrate and/or to provide an increased adhesion of a conversion coating formed by the treatment onto the surface to further coatings applied onto the conversion coating.

A further subject-matter of the present invention is a substrate comprising at least one surface, wherein said surface is at least partially made of at least one metal, preferably at least partially made of aluminum and/or an aluminum alloy, wherein said surface has been treated according to the inventive method and/or by the inventive acidic composition (A).

It has been surprisingly found that due to the presence of the inventively used polymer (P) in composition (A) the properties of conversion coatings formed by the contacting step (1), particularly the ability to serve as adhesion promoters for further coatings applied thereon can be significantly improved.

It has been further surprisingly found that due to the presence of the inventively used polymer (P) in composition (A) also the corrosive subsurface migration and/or diffusion is/are significantly reduced. It has been in particular found that filiform corrosion is significantly reduced.

Additionally, it has been surprisingly found that no cracks at all are observed when inventive coated substrates are subjected to a bend test, in particular when aluminum copper alloy and aluminum zinc alloy substrates are used.

Moreover, it has been surprisingly found that the inventive method is economically advantageous as it can be performed in shorter time, energy and labor as the method allows a formation of a single conversion coating layer in a single step. In particular, no conventionally used further treatment steps such as a phosphonate treatment step are necessary by using the inventive method. Further, it has been surprisingly found that the inventive method is also ecologically advantageous as no harmful constituents such as chromium containing compounds, in particular Cr(VI) ions, and/or phosphonates have to be present in composition, and that nonetheless excellent adhesion and anti-corrosion properties are obtained, in particular when substrates made of an aluminum copper or zinc alloy are used.

### DETAILED DESCRIPTION OF THE INVENTION

The term “comprising” in the sense of the present invention, in particular in connection with the inventive method, the inventive(ly used) composition (A) and the inventive master batch, preferably has the meaning “consisting of”. In this case, for example, with regard to inventive composition (A), in addition to the mandatory constituents therein (constituents (a) and (b) and water) one or more of the other optional constituents mentioned hereinafter may be contained in the composition. All constituents can be present in each case in their preferred embodiments mentioned hereinafter. The same applies to the further subject-matter of the present invention.

### Inventive Method

The inventive method is a method for treatment of at least one surface of a substrate, wherein said surface is at least partially made of at least one metal, in particular at least partially made of aluminum and/or an aluminum alloy, comprising at least contacting step (1).

Preferably, the inventive method does not contain any step involving a phosphonate treatment. More preferably, the inventive method does not contain any other step involving any treatment, wherein any further conversion coating film is applied onto the substrate despite the conversion coating film obtained after contacting step (1).

Preferably, the inventive method does not contain any step involving any treatment with chromium ions such as Cr(VI) ions.

### Substrate

At least one region of the surface of the substrate is made of at least one metal, preferably made of aluminum and/or of an aluminum alloy. Other examples of metal are different kinds of steel. The surface of the substrate can consist of different regions comprising different metals and/or alloys. However, at least one region of the surface of the substrate is preferably of aluminum and/or an aluminum alloy. Preferably, the overall surface of the substrate is made of aluminum and/or of an aluminum alloy.

More preferably, the substrate as such consists of aluminum and/or of an aluminum alloy, even more preferably of an aluminum alloy.

In case of an aluminum alloy said alloy preferably contains more than 50 wt.-% of aluminum, based on the total weight of the alloy. The method of the invention is in particular suitable for all aluminum alloys containing more than 50 wt.-% aluminum, particularly for aluminum magnesium alloys, including, but not limited to AA5005, as well as for aluminum magnesium silicon alloys, including, but not limited to AA6014, AA6060 and AA6063, for cast alloys—e.g. AlSi7Mg, AlSi9Mg, AlSi10Mg, AlSi11Mg, AlSi12Mg—as well as for forge alloys—e.g. AlSiMg. Aluminum magnesium alloys, including AA5005, as well as aluminum magnesium silicon alloys, including AA6060 and AA6063, are commonly used in the field of aluminum finishing and/or for the treatment of wheels and/or in other vehicle parts such as electrical vehicle parts, e.g. battery housings. However, the method is principally suited for all alloys of the so-called AA1000, AA2000, AA3000, AA4000, AA5000, AA6000, AA7000 as well as AA8000 series. A preferred example of the AA2000 series is AA2024. A preferred example of the AA7000 series is AA7075. AA2024 and AA7075 are often used in the aerospace industry.

Most preferred aluminum alloys are selected from the group consisting of aluminum magnesium alloys, aluminum magnesium silicon alloys, aluminum copper alloys, aluminum zinc alloys, and aluminum zinc copper alloys.

The substrates can be wheels or other parts such as automotive parts including vehicle parts in turn including electrical vehicle parts such as battery housings, workpieces and coils. In this case, the substrate preferably is made of an aluminum magnesium alloy or an aluminum magnesium silicon alloy. The substrates can be parts usable for construction of aeroplanes. In this case, the substrate preferably is made of an aluminum copper alloy or an aluminum zinc alloy.

### Contacting Step (1)

Step (1) of the inventive method is a contacting step, wherein the at least one surface of the substrate is contacted with an acidic aqueous composition (A).

The surfaces to be treated may be cleaned by means of an acidic, alkaline or pH-neutral cleaning composition and/or etched before treatment with the acidic aqueous composition (A). The treatment procedure according to step (1), i.e. the “contacting”, can, for example, include a spray coating and/or a dip coating procedure. The composition (A) can also be applied by flooding the surface or by roll coating or even manually by wiping or brushing.

The treatment time, i.e. the period of time the surface is contacted with the acidic aqueous composition (A) used in the method for treatment of a surface according to the invention, is preferably from 15 seconds to 20 minutes, more preferably from 30 seconds to 10 minutes, and most preferably 45 seconds to 5 minutes, as for example 1 to 3 minutes.

The temperature of the acidic aqueous composition (A) used in the inventive method for treatment is preferably from 5 to 50° C., more preferably from 15 to 45° C. and most preferably from 25 to 40° C.

By performing step (1) the inventive method a conversion coating film is formed on the surface of the substrate, which has been in contact with the acidic aqueous composition (A). Preferably, a coating layer is preferably formed after drying that preferably has a coating weight determined by XRF (X-ray fluorescence spectroscopy) of:
0.5 to 200, more preferably 0.75 to 100 and most preferably 1 to 50 mg/m², of the at least one metal ion used as constituent (a), calculated as metal, and/or
1 to 50 mg/m², more preferably 2 to 40 mg/m², and most preferably 3 to 35 mg/m² of the at least one polymer (P) used as constituent (b), calculated as sulfur.

### Optional Further Steps of the Inventive Method

Prior to step (1) one or more of the following optional steps can be performed in this order:
Step (A-1): cleaning and optionally subsequently rinsing the surface of the substrate,
Step (B-1): subjecting the surface of the substrate to acidic pickling, i.e., etching, and subsequently rinsing the surface of the substrate,
Step (C-1): contacting the surface of the substrate with an aqueous composition comprising at least one mineral acid, said aqueous composition being different from composition (A) or alternatively with an aqueous alkaline composition or pH-neutral aqueous composition and
Step (D-1): rinsing the surface of the substrate obtained after the contact according to step (C-1) and/or (B-1).

Alternatively, steps (A-1) and (B-1) may be performed in one step, which is preferred. Preferably, both steps (A-1) and (B-1) are performed.

Optional step (C-1) serves to remove aluminum oxide, undesired alloy components, the skin, brushing dust etc. from the surface of the substrate and to thereby activate the surface for the subsequent conversion treatment in step (1) of the method according to the invention. This step represents an etching step.

Preferably, the at least one mineral acid of the composition in step (C-1) is sulfuric acid and/or nitric acid, more preferably sulfuric acid. The content of the at least one mineral acid is preferably in the range of 1.5 to 75 g/l, more preferably of 2 to 60 g/I and most preferably of 3 to 55 g/l. The composition used in step (C-1) preferably additionally comprises one or more metal ions selected from the group of titanium, zirconium, hafnium ions and mixtures thereof. In the treatment of parts, the duration of treatment with the composition in step (C-1) is preferably in the range of 30 seconds to 10 minutes, more preferably of 40 seconds to 6 minutes and most preferably of 45 seconds to 4 minutes. The treatment temperature is preferably in the range of 20 to 55° C., more preferably of 25 to 50° C. and most preferably of 30 to 45° C. In the treatment of coils, the duration of treatment is preferably in the range of 3 seconds to 1 minute, most preferably of 5 to 20 seconds.

Rinsing step (D-1) and the optional rinsing being part of step (A-1) are preferably performed by using deionized water or tap water. Preferably, step (D-1) is performed by using deionized water.

After having performed mandatory step (1) of the inventive method one or more of the following optional steps can be performed in this order:
Step (2): rinsing the surface of the substrate obtained after the contact according to step (1),
Step (3): contacting the surface of the substrate obtained after step (1) or after optional step (2) with an aqueous acidic composition (B) being the same or different from composition (A),
Step (4): rinsing the surface of the substrate obtained after the contact according to step (3), and
Step (5): drying the surface of the substrate obtained after the contact according to step (1), after the rinsing of step (2), after the contact according to step (3) or after the rinsing of step (4).

After step (1) of the method according to the invention the surface of the substrate obtained after contact according to step (1) can be rinsed, preferably with deionized water or tap water (optional step (2)). After optional step (3) of the method according to the invention the surface of the substrate obtained after contact according to optional step (3) can be rinsed, preferably with water (optional step (4)).

Rinsing steps (2) and (4) may be carried out in order to remove excess components present in composition (A) used in step (1) and optionally also in the composition used in optional step (3) such as for example the polymer (P) and/or disruptive ions from the substrate.

In one preferred embodiment, rinsing step (2) is carried out after step (1). In another preferred embodiment, no rinsing step (2) is performed. In both embodiments, an additional drying step (5) is preferably performed. By drying step (5) at least the conversion coating film present on the surface of the substrate is dried and becomes a coating layer.

The aqueous composition (B) applied in step optional step (3) of the method according to the invention may for example be another composition as used in step (1), i.e. a composition, which is different from the composition (A) used in step (1), but does not necessarily have to, i.e. can be identical to composition (A).

The surfaces of the inventively used substrate can be coated by further, i.e. subsequent coatings. The inventive method thus may contain at least one further optional step, namely
Step (6): applying at least one coating composition to the surface of the substrate obtained after step (1) or after any of optional steps (2) to (5) to form a coating film upon the surface, said coating film being different from the conversion coating film obtained after step (1).

The coating composition used in step (6) is different from compositions (A) and (B) and preferably comprises at least one polymer being suitable as binder, said polymer being different from polymer (P). Examples of such polymers being different from polymer (P) are in particular polyesters, polyurethanes, epoxy-based polymers (epoxy resins) and/or (meth)acrylic copolymers. If applicable, these polymers are used in combination with crosslinking agents such as blocked polyisocyanates and/or aminoplast resins.

Preferably, step (6) is performed. The coating composition used in step (6) can be a powder coating composition. Alternatively, it can be a solventborne or aqueous coating composition. Preferably, a powder coating composition is used. Any conventional powder coating composition may be used in such a step. The coating composition used in step (6) can be an adhesive such as epoxy resin adhesive and/or a polyurethane adhesive, in particular in each case a structural adhesive.

Preferably, the inventive method comprises said step (6) as an additional coating step of applying at least one coating composition to the surface of the substrate obtained after the contacting step (1)—i.e. to the surface of the substrate bearing a conversion coating layer due to having performed step (1), to form at least one further coating layer upon the surface, wherein optionally after step (1) a rinsing step (2) is carried out prior to said coating step (6). Independently whether said optional rinsing step (2) is performed or not, a drying step (5) is preferably carried out in turn prior to coating step (6).

Before the application of further coatings according to step (6) the treated surface is preferably rinsed to remove excessive polymer (P) as well as optionally present unwanted ions.

The subsequent coatings can be applied wet-on-wet onto the metallic surface as treated in the method for treatment according to the invention. However, it is also possible to dry the metallic surface as treated according to the invention in step (5) before applying any further coating.

### Composition (A) Used in Step (1) of the Inventive Method

The acidic aqueous composition (A) used in step (1) is preferably free of any chromium ions such as Cr(VI) cations.

The acidic aqueous composition (A) used in step (1) is preferably free of any phosphonate anions.

The term “aqueous” with respect to the inventively used composition (A) in the sense of the present invention preferably means that the composition (A) is a composition containing at least 50 wt.-%, preferably at least 60 wt.-%, more preferably at least 70 wt.-% in particular at least 80 wt.-%, most preferably at least 90 wt.-% of water, based on its total content of organic and inorganic solvents including water. Thus, the composition (A) may contain at least one organic solvent besides water—however, in an amount lower than the amount of water present.

Preferably, the acidic aqueous composition (A) contains at least 50 wt.-%, preferably at least 60 wt.-%, more preferably at least 70 wt.-% in particular at least 80 wt.-%, most preferably at least 90 wt.-% of water, in each case based on its total weight.

The term “acidic” means that the composition (A) has a pH value of less than 7 at room temperature (23° C.). The pH value of the acidic aqueous composition is preferably in the range in the range of from 0.1 to 6.0, preferably of from 0.2 to 5.5, more preferably of from 0.3 to 5.0, even more preferably of from 0.5 to 4.5, yet more preferably of from 1.0 to 4.2, most preferably of from 1.5 to 4.0. Alternatively, the pH value is preferably in the range in the range of from 0.5 to 6.9 or of 0.5 to 6.5, more preferred 2.0 to 6.0, even more preferred 2.5 to 5.5, particularly preferred 2.8 to 5.0 and most preferred 2.9 to 4.5. The pH can be preferably adjusted by using nitric acid, aqueous ammonia and/or sodium carbonate.

The acidic aqueous composition (A) can be used as a dip coat bath. However, it can also be applied to the aluminum containing surfaces by virtually any conventional coating procedure like e.g. spray coating, roll coating, brushing, wiping etc. as outlined above in connection with step (1). Spraying is preferred.

The inventively used acidic aqueous composition (A) may comprise further components including ions as lined out in the detailed description hereinafter. The term “further comprises”, as used herein throughout the description in view of the ingredients of acidic aqueous compositions, means “in addition to the mandatory constituents (a) and (b) as well as water. Therefore, such “further” compounds including ions differ from the mandatory ingredients (a) and (b).

The terms “constituents” and “components” used herein are inter-changeable.

The total amount of all components (constituents) present in the inventive composition (A) adds up to 100 wt.-%.

Composition (A) can be a dispersion or solution. Preferably, it is a solution.

### Metal Ions as Constituent (a)

Composition (A) contains at least one metal ion selected from the group of titanium, zirconium, hafnium ions and mixtures thereof. Particularly preferred are titanium, and zirconium, ions and mixtures thereof. Most preferred are zirconium ions.

Preferably, the at least one metal ion selected from the group of titanium, zirconium, hafnium ions and mixtures thereof, preferably selected from the group of zirconium and titanium ions, is present in composition (A) in an amount in a range of from 5 to 5000 ppm, more preferably of from 7.5 to 4000 ppm, still more preferably of from 10 to 3000 ppm, even more preferably of from 12.5 to 2000 ppm, yet more preferably of from 15 to 1000 ppm, in particular of from 17.5 to 500 ppm, more particularly of from 20 to 300 ppm, most preferably of from 30 to 200 ppm, in each case calculated as metal.

Preferably, the amount of component (a) in ppm in the composition (A) is lower than the amount of component (b) in ppm.

Preferably, a precursor metal compound is used to generate the ions as constituent (a) in composition (A). Preferably, the precursor metal compound is water-soluble. Solubility is determined at a temperature of 20° C. and atmospheric pressure (1.013 bar).

The content of component (a) can be monitored and determined by the means of ICP-OES (optical emission spectroscopy with inductively coupled plasma). Said method is described hereinafter in detail.

Particularly preferred titanium, zirconium and hafnium compounds used as precursor metal compounds are the complex fluorides of these metals. The term “complex fluoride” includes the single and multiple protonated forms as well as the deprotonated forms. It is also possible to use mixtures of such complex fluorides. Complex fluorides in the sense of the present invention are complexes of titanium, zirconium and/or hafnium formed with fluoride ions in composition (A), e.g. by coordination of fluoride anions to titanium, zirconium and/or hafnium cations in the presence of water.

Moreover, zirconium can also be added in form of zirconyl compounds as e.g. zirconyl nitrate and zirconyl acetate, or zirconium carbonate or zirconium nitrate, the latter one being particularly preferred. The same applies to titanium and hafnium.

### Polymer (P) as Constituent (b)

Composition (A) contains at least one polymer (P), wherein the polymer (P) is a copolymer obtained from at least two different ethylenically unsaturated monomers, and wherein the polymer (P) comprises at least two kinds of side chains (S1) and (S2), which are different from each other, wherein side chain (S1) comprises at least one functional group selected from the group consisting of hydroxyl groups and carboxylic acid groups and mixtures thereof, and side chain (S2) comprises at least one sulfur-containing moiety. Polymer (P) may comprise different kinds of side chains (S1), which, however, each contain at least one functional group selected from the group consisting of hydroxyl groups and carboxylic acid groups and mixtures thereof. Likewise, polymer (P) may comprise different kinds of side chains (S2), which, however, each contain at least one sulfur-containing moiety. The type of sulfur-containing moieties may be different in case of each side chain (S2).

Polymer (P) is preferably soluble in acidic composition (A). Solubility is determined at a temperature of 20° C. and atmospheric pressure (1.013 bar).

Polymer (P) is preferably present in composition (A) in an amount in the range of from 20 to 1000 ppm, more preferably in the range of from 30 to 900 ppm, even more preferably in the range of from 40 to 800 ppm, still more preferably in the range of from 50 to 700 ppm, yet more preferably in the range of from 60 to 600 ppm, in particular of from 80 to 550 ppm, more particularly of from 100 to 500 ppm.

Preferably, the ethylenically unsaturated monomers used for preparing polymer (P) are selected from vinyl monomers and (meth)acrylic monomers.

The term “(meth)acryl” means “acryl” and/or “methacryl”. Similarly, “(meth)acrylate” means acrylate and/or methacrylate. Polymer (P) is preferably a “(meth)acryl polymer”, which is formed from “acryl monomers” and/or “methacryl monomers”, but additionally may contain non-acryl and non-methacryl monomeric units if other ethylenically unsaturated monomers such as vinyl monomers are additionally used. Preferably, the backbone of the (meth)acryl polymer (P) is formed from more than 50 mol-%, even more preferably of from more than 75 mol-%, of (meth)acryl monomers.

Preferably, polymer (P) is a (meth)acrylic copolymer and comprises a polymeric backbone and at least two kinds of side chains (S1) and (S2) attached to said polymeric backbone, which are different from each other.

By use of the at least two different ethylenically unsaturated monomers in a copolymerization for generating the polymer (P), polymerized monomeric units of these monomers are formed. Each kind of units is generated by polymerization of the respective monomer. For example, the polymerized monomeric unit of vinyl mercaptoethanol (H₂C═CH—S—C₂H₄OH) is H₂C*—C*H—S—C₂H₄OH, wherein the asterisks denote the carbon atoms bound to the adjacent polymerized monomeric units, which form the polymeric backbone of polymer (P).

Preferably, at least one of the at least two different ethylenically unsaturated monomers leads to the formation of monomeric units (s1) in polymer (P) having side chains (S1). Preferably, the at least one further monomer being different from monomer (s1) leads to the formation of monomeric units (s2) in polymer (P) having side chains (S2). The inventively used polymer (P) may contain only one kind of each of monomeric units (s1) and (s2), but also may comprise different kinds of monomeric units (s1) and/or different kinds of monomeric units (s2). For example, both 2-hydroxyethyl (meth)acrylate and 3-hydroxypropyl (meth)acrylate can be used for construction of monomeric units having side chains (S1) containing an OH-group.

As outlined above monomeric unit (s1) contains at least one side chain (S1) and is prepared by making use of at least one suitable monomer. Monomeric unit (s2) contains at least one side chain (S2) and is prepared by making use of at least one suitable monomer (s2), which is suitable for introducing the at least one side chain (S2) into the copolymer during polymerization or afterwards in a polymer analogous reaction. The copolymer may further comprise at least one additional monomeric unit (s3), which contains at least one side chain (S3) and is prepared by making use of at least one suitable monomer (s3), monomeric unit (s3) being different from both (s1) and (s2).

Polymer (P) preferably is a linear polymer. The monomeric units present in polymer (P) can be arranged statistically, in two or more blocks or as a gradient along the polymeric backbone of polymer (P). Such arrangements can also be combined. Preferably, polymer (P) has a statistical distribution and can be prepared by conventional radical polymerization. If polymer (P) is a block copolymer it can be preferably prepared by controlled radical polymerization.

Preferably, the at least one polymer (P) has a number average molecular weight in the range of from 1 000 to 50 000 g/mol, preferably of from 1 200 to 40 000 g/mol, more preferably of from 1 500 to 35 000 g/mol, still more preferably of from 1 700 to 30 000 g/mol. The number average molecular weight is determined by the method described hereinafter in the ‘methods’ section.

Preferably, the polydispersity of polymer (P) exceeds 1.5, more preferably exceeds 2.0. Preferably, the polydispersity is in a range of from >2.0 to 3.9. The polydispersity is determined by the method described hereinafter in the ‘methods’ section.

Preferably, polymer (P) does not contain any phosphonic acid and/or phosphonate groups.

Preferably, the number of monomeric units (s1) in polymer (P) in mol-% is greater than the number of monomeric units (s2) in the polymer (P) in mol-%.

Preferably, the relative molar ratio of the at least one monomeric unit (s1) to the at least one monomeric unit (s2) in the polymer (P) is in the range of from 20:1 to 1:1, more preferably in the range of from 15:1 to 1.5:1, even more preferably in the range of from 10:1 to 1.7:1, still more preferably in the range of from 5:1 to 2:1, in particular of from 4:1 to 2.2:1.

Preferably, polymer (P), contains
monomeric units (s1) present in the polymer, which each contain a side chain (S1) comprising at least one functional group selected from the group consisting of hydroxyl groups and carboxylic acid groups and mixtures thereof in an amount of 50 to 99 mol-%, more preferably of 55 to 95 mol-%, even more preferably of 60 to 90 mol-%, yet more preferably of 65 to 85 mol-%, and/or
monomeric units (s2) present in the polymer being different from monomeric units (s1), which each contain a side chain (S2) comprising at least one sulfur-containing moiety in an amount of 1 to 50 mol-%, more preferably of 5 to 45 mol-%, even more preferably of 10 to 40 mol-%, yet more preferably of 15 to 35 mol-%,
   in each case based on the total amount of all monomeric units of polymer (P), wherein the sum of all monomeric units present in polymer (P) adds up to 100 mol-%.

### Side Chains (S1)

Side chain (S1) comprises at least one functional group selected from the group consisting of hydroxyl groups and carboxylic acid groups and mixtures thereof. Monomers suitable of forming monomeric units (s1) comprising side chains (S1) are preferably used for preparing polymer (P). The functional groups of side chains (S1) not only allow crosslinking reactions to take place when a further coating film is applied on top of the conversion coating film obtained after performing step (1) of the inventive method, when the coating composition used for forming the further coating film comprises suitable film-forming polymers and/or crosslinking agent having in turn functional groups that are reactive towards the functional groups of side chain (S1), but the functional groups of side chains (S1) additionally are relevant in order to ensure that polymer (P) has a sufficient solubility in water and thus in the aqueous composition (A).

Preferably, at least one monomer selected from the group consisting of preferably (meth)acrylic monomers having at least one OH-group and/or at least one COOH-group. Examples of such monomers are 2-hydroxyethyl acrylate, 2-hydroxyethyl methacrylate, 3-hydroxypropyl acrylate, 3-hydroxypropyl methacrylate, 4-hydroxybutyl acrylate, 4-hydroxybutyl methacrylate, 3-phenoxy-2-hydroxypropyl (meth)acrylate, glycerol mono (meth)acrylate, N-(2-hydroxypropyl) (meth)acrylamide, allyl alcohol, hydroxystyrene, hydroxyalkyl vinyl ethers such as hydroxybutyl vinyl ether and vinylbenzyl alcohol as well as acrylic acid and methacrylic acid.

### Side Chains (S2)

Side chain (S2) comprises at least one sulfur-containing.

Preferably, the at least one sulfur-containing moiety of side chain (S2) is a moiety selected from the group of thiol groups, thioether groups, thioester groups and thiocarboxylic acid groups as well as mixtures thereof.

Preferably, side chain (S2) additionally contains at least one functional group selected from OH-groups, COOH-groups, and primary and secondary amino groups, in particular NH₂-groups.

Preferably, monomers suitable of forming monomeric units (s2) comprising side chains (S2) containing in turn at least one sulfur-containing moiety are used for preparing polymer (P). Examples of such monomers are vinyl mercapto alcohols such as vinyl mercaptoethanol, vinyl thiazoles and vinyl thiophenes. Vinyl mercapto alcohols such as vinyl mercaptoethanol are most preferred.

Alternatively, it is also possible to introduce said moiety into the side chain of the polymer not already during polymerization but afterwards in a polymer analogous reaction. Preferably, in case of introducing said moiety after the polymerization has taken place, a monomer comprising a suitable moiety for later modification is used for polymerization. Preferably, at least one monomer selected from the group consisting of preferably (meth)acrylic monomers having at least one epoxide group are used. Most preferred is glycidyl (meth)acrylate. Thus, a precursor polymer with side chains comprising at least one epoxide moiety can be used as precursor for preparing a polymer (P) comprises at least one sulfur-containing moiety in its side chains (S2).

For introducing the at least one sulfur-containing moiety in the side chains (S2) in a polymer analogous reaction a suitable S-containing compound is used, preferably a compound having at least one thiol group. Said thiol group can react with the epoxide moiety after ring opening of the epoxide group and form the at least one sulfur-containing moiety. Preferably, the S-containing compound is selected from the groups consisting of dithiols such as 1,2-ethandithiols, mercaptoalcohols such as mercapoethanol, thiocarboxylic acids such as thioacetic acid (CH₃—C(═O)SH), mercaptoacids such as HS—CH₂—C(═O)OH, mercaptoacid esters such as HS—CH₂—C(═O)R, wherein R is a hydrocarbyl group, preferably is an aliphatic group, and mercapto-functional compounds bearing more than one further functional group such as both at least one amino and at least one carboxylic acid groups, e.g. L-cysteine.

Most preferred are mercaptoalcohols and mercapto-functional compounds bearing more than one further functional group such as both at least one amino and at least one carboxylic acid groups, e.g. L-cysteine.

In case the least one sulfur-containing moiety is introduced into the side chains (S2) in a polymer analogous reaction by making use of an already existing side chain containing an epoxide group, preferably at least 90 mol-%, more preferably at least 95 mol-%, even more preferably at least 98 mol-% and in particular all of the originally present epoxide groups have undergone transformation.

### Optionally Present Further Side Chains (S3)

Optionally, polymer (P) further contains monomeric units (s3) present in the polymer, which are different from both monomeric units (s1) and (s2). Monomeric units (s3) contain side chains (S3). If such monomeric units (s3) are present, they are preferably present in low amounts such as amounts of up to 30 mol-% at most in order to not interfere with the water solubility of polymer (P).

Examples of suitable monomers for building up the polymeric backbone of the inventive copolymer and for simultaneous incorporation of the one or more optional side chains (S3) are (meth)acrylic esters of an aliphatic C₁-C₃₀-monoalcohol such as methyl (meth)acrylate, ethyl (meth)acrylate, n-propyl (meth)acrylate), i-propyl (meth)acrylate, n-butyl acrylate, n-butyl methacrylate, i-butyl acrylate, i-butyl methacrylate, t-butyl acrylate, t-butyl methacrylate, lauryl acrylate, lauryl methacrylate, 2-ethylhexyl acrylate, 2-ethylhexyl methacrylate, stearyl acrylate, stearyl methacrylate, behenyl acrylate, behenyl methacrylate, cyclohexyl acrylate, cyclohexyl methacrylate, isobornyl acrylate and isobornyl methacrylate.

It is also possible to use other ethylenically unsaturated monomers as monomers for constructing monomeric units (s3) for building up the polymeric backbone of the polymer (P) and for incorporation of the one or more side chains (S3), namely such monomers, which bear at least one amino group such as N,N-dimethylaminoethyl acrylate, N,N-dimethylaminoethyl methacrylate, N,N-dimethylaminopropyl acrylate, N,N-dimethylaminopropyl methacrylate, 2-(N,N-diethylamino)ethyl (meth)acrylate, 2-(N,N-dimethylamino)ethyl (meth)acrylate, N-[3-(N,N-dimethylamino)propyl](meth)acrylamide, 3-dimethylaminoneopentyl (meth)acrylate, 2-N-morpholinoethyl (meth)acrylate, N-[3-(N,N-dimethylamino)propyl] (meth)acrylamide, 2-(N,N-diethylamino)ethyl (meth)acrylamide, 2-(tert-butylamino)ethyl (meth)acrylate, 2-diisopropylaminoethyl (meth)acrylate, N-dodecylacrylamide and N-[2-(N,N-Dimethylamino)ethyl] (meth)acrylamide, N,N-Dimethyl (meth)acrylamide, 2-vinylpyridine, 4-vinylpyridine, allyl amine, (meth)acryl amide and vinylimidazole as well as N,N-diethylaminostyrene (all isomers) and N,N-diethylamino-alpha-methylstyrene (all isomers). Among these examples, the (meth)acrylate and (meth)acrylamide based monomers are preferred. (Meth)acrylate monomers are very preferred. Particularly preferred amino-group containing monomers are N,N-dimethylaminoethyl acrylate, N,N-dimethylaminoethyl methacrylate, N,N-dimethylaminopropyl acrylate and N,N-dimethylaminopropyl methacrylate or mixtures thereof.

### Further Optional Constituents

The inventive(ly) used acidic aqueous composition (A) preferably contains free fluorides. These may result from the presence of component (a), i.e. in particular when complex fluorides of Ti, Zr and/or Hf are present in (A) as component (a), but may also or alternatively result from the presence of other optional components as described hereinafter. Preferably, the acidic aqueous composition (A) contains free fluoride ions in an amount in the range of from 1 to 500 ppm, more preferably of from 1.5 to 200 ppm, even more preferably of from 2 to 100 ppm, in particular of from 2.5 to 50 ppm. The free fluoride content is determined by means of a fluoride ion sensitive electrode according to the method disclosed in the ‘methods’ section.

Optionally, aqueous composition (A) further comprises at least one kind of metal cations selected from the group of cations of metals of the 1^{st} to 3^{rd} subgroup (copper, zinc and scandium groups) and 5^{th} to 8^{th} subgroup (vanadium, chromium, manganese, iron, cobalt and nickel groups) of the periodic table of the elements including the lanthanides as well as the 2^{nd} main group of the periodic table of the elements (alkaline earth metal group), lithium, bismuth and tin. The before-mentioned metal cations are different from constituent (a) and are generally introduced in form of their water-soluble compounds, preferably as their water-soluble salts. Preferred cation(s) is/are selected from the group consisting of cations of cerium and the other lanthanides, chromium, iron, calcium, cobalt, copper, magnesium, manganese, molybdenum, nickel, niobium, tantalum, yttrium, vanadium, lithium, bismuth, zinc and tin. Most preferred are molybdenum cations and/or vanadium cations, in particular molybdenum cations, having a concentration in the range of from 1 to 400 ppm, more preferably of from 2 to 300 ppm, even more preferably of from 4 to 75 ppm, still more preferably of from 5 to 50 ppm, yet more preferably of from 7.5 to 30 ppm and in particular of from 10 to 20 ppm, calculated in each case as metal(s). If molybdenum cations are present in composition (A) for preparing the aqueous composition (A), preferably a water-soluble (at a temperature of 20° C. and atmospheric pressure (1.013 bar)) molybdenum salt is used such as molybdenum sulfate and/or nitrate. Molybdenum sulfate is in particular preferred.

Preferably, composition (A) comprises molybdenum cations, preferably in an amount in a range of from 1 to 400 ppm, more preferably of from 2 to 300 ppm, even more preferably of from 4 to 75 ppm, still more preferably of from 5 to 50 ppm, yet more preferably of from 7.5 to 30 ppm and in particular of from 10 to 20 ppm, calculated in each case as metal.

Optionally, aqueous composition (A) further comprises at least one pH-Value adjusting substances, preferably selected from the group consisting of nitric acid, sulfuric acid, methanesulfonic acid, acetic acid, aqueous ammonia, sodium hydroxide and sodium carbonate, wherein nitric acid, aqueous ammonia and sodium carbonate are preferred. Depending on the pH value of the acidic aqueous composition (A), the above compounds can be in their fully or partially deprotonated form or in protonated forms.

Optionally, aqueous composition (A) further comprises at least one water-soluble fluorine compound. Examples of such water-soluble fluorine compounds are fluorides as well as hydrofluoric acid. In particular, such a compound is present in composition (A), when component (a) is not present in the form of a complex fluoride of titanium, zirconium and/or hafnium in composition (A).

Optionally, aqueous composition (A) further comprises at least one (poly)methacrylic acid, preferably having a number average molecular weight in a range of from 1,000 to 250,000 g/mol. Preferably, such a constituent is present in an amount of from 50 to 5000 ppm in composition (A).

Optionally, aqueous composition (A) further comprises at least one corrosion inhibitor. Examples are L-cysteine and other amino acids, benzotriazoles and mixtures thereof. Preferably, the at least one corrosion inhibitor does not comprise any kind of metal ions.

### Inventive Composition (A)

A further subject-matter of the present invention is an acidic aqueous composition (A), said acidic aqueous composition (A) being the one used in the above defined contacting step (1) of the inventive method.

All preferred embodiments described above herein in connection with the inventive method and the inventively used composition (A), which is used in the contacting step (1) of said method, and the constituents contained therein, in particular components (a), (b) and water, but also optional components are also preferred embodiments of inventive acidic aqueous composition (A) as such.

### Inventive Master Batch

A further subject-matter of the present invention is a master batch to produce the inventive acidic aqueous composition (A) by diluting the master batch with water and optionally adjusting the pH value.

All preferred embodiments described above herein in connection with the inventive method and the inventive composition (A), which is used in the contacting step (1) of said method, and the constituents contained therein, in particular components (a) and (b) besides water, but also optional components as well as described above herein in connection with acidic aqueous composition (A) as such are also preferred embodiments of the inventive master batch.

If a master batch is used to produce the acidic aqueous composition (A) according to the present invention, the master batch typically contains the ingredients of the acidic aqueous composition (A) to be produced in the desired proportions, namely constituents (a) and (b), but at a higher concentration. Such master batch is preferably diluted with water to the concentrations of ingredients as disclosed above to form the acidic aqueous composition (A). If necessary, the pH value of the acidic aqueous composition may be adjusted after dilution of the master batch.

Of course, it is also possible to further add any of the optional constituents to the water, wherein the master batch is diluted or to add any of the optional constituents after diluting the master batch with water. It is however preferred that the master batch already contains all necessary constituents.

Preferably, the master batch is diluted with water and/or an aqueous solution in the ratio of 1:5,000 to 1:10, more preferred 1:1,000 to 1:10, most preferred in the ratio of 1:300 to 1:10 and even more preferred 1:150 to 1:50.

### Inventive Use

A further subject-matter of the present invention is a use of the inventive acidic aqueous composition (A) for treating at least one surface of a substrate, wherein said surface is at least partially made of at least one metal, preferably at least partially made of aluminum and/or an aluminum alloy, preferably to provide corrosion protection to the surface and/or to the substrate and/or to provide an increased adhesion of a conversion coating formed by the treatment onto the surface to further coatings applied onto the conversion coating.

All preferred embodiments described above herein in connection with the inventive method and the inventive composition (A), which is used in the contacting step (1) of said method, as well as the inventive master batch, and the constituents contained therein and in the composition, in particular components (a) and (b) besides water, but also optional components, as well as described above herein in connection with acidic aqueous composition (A) as such are also preferred embodiments of the inventive use.

### Inventive Substrate

A further subject-matter of the present invention is a substrate comprising at least one surface, wherein said surface is at least partially made of at least one metal, preferably at least partially made of aluminum and/or an aluminum alloy, wherein said surface has been treated according to the inventive method and/or by the inventive acidic composition (A). By the inventive treatment a conversion coating film is formed and thus present on the substrate. Thus, the inventive substrate represents a coated substrate.

All preferred embodiments described above herein in connection with the inventive method and the inventive composition (A), which is used in the contacting step (1) of said method, as well as the inventive master batch, and the constituents contained therein and in the composition, in particular components (a) and (b) besides water, but also optional components, as well as described above herein in connection with acidic aqueous composition (A) as such, and the inventive use, are also preferred embodiments of the inventive substrate.

### Methods

1. Determination of Average Molecular Weights M_{w} and Mₙ

The number average and weight average molecular weights (Mₙ and M_{w}), respectively, are measured according to the following protocol: Samples are analyzed by SEC (size exclusion chromatography) equipped with a MALS detector. Absolute molar masses are obtained with a dn/dC value chosen equal to 0.1875 mL/g in order to get a recovery mass around 90%. Polymer samples are dissolved in the mobile phase and the resulting solutions are filtrated with a Millipore filter 0.45 μm. Eluting conditions are the following ones. Mobile phase: H₂O 100% vol. 0.1 M NaCl, 25 mM NaH₂PO₄, 25 mM Na₂HPO₄; 100 ppm NaN₃; flow rate: 1 mL/min; columns: Varian Aquagel OH mixed H, 8 μm, 3*30 cm; detection: RI (concentration detector Agilent)+MALLS (Multi Angle Laser Light Scattering) Mini Dawn Tristar+UV at 290 nm; samples concentration: around 0.5 wt % in the mobile phase; injection loop: 100 μL. Polydispersity P can be calculated from the Mₙ and M_{w} values obtained.

### 2. Free Fluoride Content Determination

The free fluoride content is determined by means of a fluoride ion selective electrode. The electrode is calibrated using at least three master solutions with known fluoride concentrations. The calibration process results in the building of calibration curve. Then the fluoride content is determined by using of the curve.

### 3. ICP-OES

The amount of certain elements in a sample under analysis, such as of titanium, zirconium and hafnium, being present in component (a), is determined using inductively coupled plasma atomic emission spectrometry (ICP-OES) according to DIN EN ISO 11885 (date: Sep. 1, 2009). A sample is subjected to thermal excitation in an argon plasma generated by a high-frequency field, and the light emitted due to electron transitions becomes visible as a spectral line of the corresponding wavelength, and is analyzed using an optical system. There is a linear relation between the intensity of the light emitted and the concentration of the element in question, such as titanium, zirconium and/or hafnium. Prior to implementation, using known element standards (reference standards), the calibration measurements are carried out as a function of the particular sample under analysis. These calibrations can be used to determine concentrations of unknown solutions such as the concentration of the amount of titanium, zirconium and hafnium.

### 4. Crosscut Testing to DIN EN ISO 2409 (06-2013)

The crosscut test is used to ascertain the strength of adhesion of a coating on a substrate in accordance with DIN EN ISO 2409 (06-2013). Cutter spacing is 2 mm. Assessment takes place on the basis of characteristic cross-cut values in the range from 0 (very good adhesion) to 5 (very poor adhesion). This method is used for measurement of the dry adhesion. The crosscut test is also performed after storing the sample for 48 h in water having a temperature of 63° C. in order to determine the wet adhesion. The crosscut test may also be performed after exposure for up to 240 hours in a condensation climate test according to DIN EN ISO 6270-2 CH (09-2005 and the correction of 10-2007). Each of the tests is performed three times and an average value is determined.

### 5. Filiform Corrosion (FFC)

Determining the filiform corrosion is used to ascertain the corrosion resistance of a coating on a substrate. This determination is carried out according to MBN 10494-6, 5.5 (DBL 7381) over a duration of 672 hours. The maximum thread length (LF) and/or the average undermining (MU) in [mm] is measured.

### 6. Bend Test

A bend test is performed according DIN EN ISO 6860:2006-06.

### Examples

The following examples further illustrate the invention, but are not to be construed as limiting its scope.

### 1. Preparation of Polymers

### 1.1 Polymers P1, P2, P3, P4 and P5

Each of polymers P1 to P5 has been prepared by radical polymerization of a monomer mixture in deionized water. The monomer mixture comprises vinyl mercaptoethanol (S-vinylthioethanol) and at least one of acrylic acid (in case of P1, P4 and P5) and 2-hydroxyethyl acrylate (in case of P2 and P3). In case of polymer P5 the monomer mixture additionally comprises maleic acid anhydride as further monomer.

### General Procedure:

All monomers used were copolymerized in deionized water. As monomers vinyl mercaptoethanol, one of acrylic acid and 2-hydroxyethyl acrylate, and optionally maleic acid anhydride were used. A commercially available water soluble cationic azo initiator was used.

In Table 1a the amounts of monomers used for preparing each of polymers P1 to P5 are given. VME means vinyl mercaptoethanol, AA means acrylic acid and HEA means 2-hydroxyethyl acrylate. MAH means maleic acid anhydride. The amounts given in wt.-% are based on the total weight in wt.-% of the respective monomer mixture used in each case.

TABLE 1a

| | VME | AA | HEA | MAH |
|---|---|---|---|---|
| Polymer | [wt.-%] | [wt.-%] | [wt.-%] | [wt.-%] |
| P1 | 10 | 90 | — | — |
| P2 | 10 | — | 90 | — |
| P3 | 30 | — | 70 | — |
| P4 | 30 | 70 | — | — |
| P5 | 20 | 60 | — | 20 |

The number average molecular weight Mₙ of each of polymers P1 to P5 was in the range of from 1700 to 18000 g/mol and was determined according to the method disclosed in the ‘method’ section. The polydispersity is in each case about 2.2.

### 1.2 Polymers P6a, P7a, P8a as Well as P6, P7 and P8

Polymers P6 to P8 were obtained in a 2-step method. First, precursor polymers P6a, P7a and P8a were prepared in a first step by radical copolymerization of 2-hydroxyethyl acrylate and glycidyl methacrylate in isopropanol.

### First Step—General Procedure:

All monomers used were copolymerized in isopropanol. As monomers hydroxyethyl acrylate and glycidyl methacrylate were used. A commercially available initiator was used.

In Table 1b the amounts of monomers used for preparing each of polymers P6a to P8a are given. HEA means 2-hydroxyethyl acrylate. GMA means glycidyl methacrylate. The amounts given in wt.-% are based on the total weight in wt.-% of the respective monomer mixture used in each case.

TABLE 1b

| | GMA | HEA |
|---|---|---|
| Polymer | [wt.-%] | [wt.-%] |
| P6a | 25.44 | 74.56 |
| P7a | 35 | 65 |
| P8a | 15 | 85 |

Each of precursor polymers P6a, P7a and P8a was then subjected to a post-modification reaction as a second step in deionized water by use of L-cysteine as at least one S-containing compound.

### Second Step—General Procedure:

The post-polymerization modification of each of polymer precursors P6a, P7a and P8a was carried out in deionized water at a temperature of 40° C. The respective polymer precursor was dissolved in deionized water. L-cysteine was also dissolved in water and the resulting mixture was heated in a reaction vessel under nitrogen atmosphere to 40° C. Then, the respective polymer precursor was added at 40° C. to the aqueous L-cysteine solution. After one hour of stirring, an aqueous solution of potassium hydroxide was added. The reaction was then allowed to continue for another 6 hours at 40° C. The product was filtered through a 50 μm filter. L-cysteine has been in each case used in an amount that allows a ring-opening reaction of the epoxide group of the GMA structural units present in each of P6a, P7a and P8a such that about 95 wt.-% of all epoxide groups are converted and thioether groups are formed, respectively. For example, for preparing polymer P6 17 g L-cysteine were dissolved in 100 g deionized water, heated to 40° C., and then 131.4 g of polymer precursor P6a dissolved in deionized water were added and the above mentioned protocol was followed.

The number average molecular weight Mₙ of each of P6 to P8 obtained in this manner after modification with L-cysteine was in the range of from 2000 to 13500 g/mol and was determined according to the method disclosed in the ‘method’ section. The polydispersity is in each case in the range of from 2.3 to 3.0.

### 2. Preparation of Acidic Aqueous Compositions

2.1 A number of acidic aqueous compositions have been prepared (1 L each). All aqueous compositions contained H₂ZrF₆ in an amount that corresponds to 65 ppm zirconium, calculated as metal. Each of the compositions had a pH value of 3.0. Each of the compositions contained one of polymers P1 to P6 in an amount of 200 μm. Each of the compositions prepared had a free fluoride content in the range of from 3.5 to 6.6 ppm (determined according to the method disclosed in the ‘method’ section).

In Table 2a the acidic aqueous compositions that have been prepared in this manner are summarized.

TABLE 2a

| | | Amount of | Amount | Amount |
|---|---|---|---|---|
| | | polymer | of Zr | of F⁻ |
| Composition | Polymer | [ppm] | [ppm] | [ppm] |
| A1 | P1 | 200 | 65 | 6.6 |
| A2 | P2 | 200 | 65 | 6.6 |
| A3 | P3 | 200 | 65 | 3.5 |
| A4 | P4 | 200 | 65 | 5.2 |
| A5 | P5 | 200 | 65 | 4.8 |
| A6 | P6 | 200 | 65 | 5.0 |

These acidic aqueous compositions were used for the pretreatment of substrates T1, T2 and T3 (cf. item 3., vide infra).

2.2 Two further acidic aqueous pretreatment compositions have been prepared (1 L each). All aqueous compositions contained H₂ZrF₆ in an amount that corresponds to 125 ppm zirconium, calculated as metal. Each of the compositions further contained 13.5 ppm of molybdenum, calculated as metal. Molybdenum sulfate has been used for preparing each of the compositions. Each of the compositions contained one of polymers P4 and P6 in an amount of 400 μm.

In Table 2b the acidic aqueous compositions that have been prepared in this manner are summarized.

TABLE 2b

| | | Amount of | Amount | Amount |
|---|---|---|---|---|
| | | polymer | of Mo | of Zr |
| Composition | Polymer | [ppm] | [ppm] | [ppm] |
| B1 | P4 | 400 | 13.5 | 125 |
| B2 | P6 | 400 | 13.5 | 125 |

These acidic aqueous compositions were used for the pretreatment of substrates T4 and T5 (cf. item 3., vide infra).

### 3. Pretreatment Method

3.1 Five Different Kinds of Substrates have been Used, Namely an
aluminum magnesium alloy substrate AA5005 (substrate T1),
aluminum magnesium silicon alloy substrate AA6014 (substrate T2),
aluminum magnesium silicon alloy substrate AA6060 (substrate T3),
aluminum copper alloy substrate AA2024 (substrate T4), and
aluminum zinc copper alloy substrate AA7075 (substrate T5).

### 3.2 Substrates T1, T2 and T3

These substrates were cleaned by making use of the commercial product Gardoclean® S 5201/1 (3 minutes at 63° C.). Then, rinsing with tap water was performed twice (for 30 seconds each). Next, an etching step was performed. The etching was performed by making use of a mixture of the commercial product Gardacid® 4325 (containing nitric acid; 50 g/L; Chemetall GmbH) and of the commercial product Gardobond® Additive H 7274 (containing fluoride; 7.5 g/L; Chemetall GmbH) (60 seconds). After carrying out the etching a rinsing with tap water (30 seconds) followed by rinsing with deionized water (30 seconds) was performed.

### 3.3 Substrates T4 and T5

These substrates were cleaned by making use of the commercial product Ardrox® 6490 (10 minutes at 55° C.). Then, rinsing with tap water followed by rinsing with deionized water was performed. Next, an etching step was performed. The etching was performed by making use of the commercial alkaline product Oakite® 160 (Chemetall GmbH) (30-45 seconds at 45° C.). After carrying out the etching a rinsing with tap water followed by rinsing with deionized water was performed. Then, a desmutting step was performed by making use of the commercial product Ardrox® 295GD (5 minutes at room temperature). After carrying out the dismutting step a rinsing with tap water followed by rinsing with deionized water was performed.

3.4 After performance of the steps as outlined in item 3.2 for substrates T1, T2 and T3 or of the steps as outlined in item 3.3 for substrates T4 and T5 a contacting step was carried out, i.e. the surfaces of the substrates were contacted with one of the acidic aqueous compositions described hereinbefore in item 2. in order to form a conversion coating layer on the surface of the respective substrate. The contacting step was performed in each case for 60 seconds by spraying of one of the acidic aqueous compositions onto the surfaces of the substrates. The acidic aqueous compositions were heated to 35° C. in case of use of any of compositions A1 to A6 before spraying and to 40° C. in case of any of compositions B1 and B2. As a reference example (RE) a conventional two-step contacting pretreatment was performed: an aqueous composition not containing any polymer has been used in a first contacting step (containing also 65 ppm Zr and having a pH value of 3.0) and then a second contacting step with a commercially available aqueous phosphonate containing solution (Gardobond® X 4661) has been used after rinsing.

3.5 Following the contacting step a drying step is performed (15 minutes at 60 to 70° C.) after a period of air blowing.

Afterwards, a coating layer was applied onto the conversion-coated substrates T1 to T5. In case of substrates T1 to T3 an acrylic coating material was used, namely a commercially available acrylic power coating material (PY1005 from FreiLacke). The dry layer thicknesses of these coatings obtained were in the range of from 70 to 170 μm. In case of substrates T4 and T5 a commercially available 2K epoxy based primer was used (Seevenax® 113-24 from Mankiewicz). The dry layer thicknesses of these coatings obtained were in the range of from 20 to 25 μm.

### 4. Properties of the Coated Substrates

4.1 A number of properties of the coated substrates obtained by the methods described hereinbefore in item 3. have been investigated. These properties were determined according to the test methods described hereinbefore. The results are displayed in Tables 4a and 4b as well as 4c.

TABLE 4a
Substrate T1

| | Crosscut | |
|---|---|---|
| Aqueous | after | |
| composition | condensation | Filiform |
| used for | climate test | corrosion |
| pretreatment | for 240 h | (MU) |
| RE (reference) | 0 | 2.8 |
| A1 | 0 | 0.3 |
| A2 | 0 | 0.2 |
| A3 | 0 | 0.5 |
| A4 | 0 | 0.6 |
| A5 | 0 | 0.4 |
| A6 | 1 | 0.3 |

TABLE 4b
Substrate T2

| | Crosscut | |
|---|---|---|
| Aqueous | after | |
| composition | condensation | Filiform |
| used for | climate test | corrosion |
| pretreatment | for 240 h | (MU) |
| RE (reference) | 0 | 1.3 |
| A1 | 0 | 1.5 |
| A2 | 0 | 1.1 |
| A3 | 0 | 0.5 |
| A4 | 0 | 1.3 |
| A5 | 0 | 0.9 |
| A6 | 0 | 0.5 |

TABLE 4c
Substrate T3

| | Crosscut | |
|---|---|---|
| Aqueous | after | |
| composition | condensation | Filiform |
| used for | climate test | corrosion |
| pretreatment | for 240 h | (MU) |
| RE (reference) | 0 | 1.2 |
| A1 | 0 | 1.6 |
| A2 | 0 | 1.8 |
| A3 | 0 | 0.8 |
| A4 | 0 | 1.6 |
| A5 | 1 | nd |
| A6 | 0 | 1.2 |

nd = not determined

As it is evident from Tables 4a to 4c excellent adhesion and anti-corrosion properties were obtained, when using a one-step treatment method and making use of an aqueous composition containing an inventively used polymer. Good adhesion and anti-corrosion properties were also obtained in case of some of the reference examples RE—however, only when using a two-step method and making use of a phosphonate containing solution, which is both undesired for ecological and economic reasons.

4.2 Each of the substrates T4 and T5 coated by making use of an inventive acidic aqueous coating composition B1 or B2 were subjected to a crosscut testing to DIN EN ISO 2409 (06-2013) (wet and dry adhesion) and to a bend test. These tests were performed according to the test methods described hereinbefore. Each of the coated substrates passed the bend test without any cracks and showed both a very good dry and wet adhesion.

1. A method for treatment of at least one surface of a substrate, wherein said surface is at least partially made of at least one metal, comprising:
(1) contacting the at least one surface of the substrate with an acidic aqueous composition (A), wherein the acidic aqueous composition (A) comprises
(a) at least one metal ion selected from the group consisting of titanium, zirconium, hafnium ions and mixtures thereof, and
(b) at least one polymer (P), wherein the polymer (P) is a copolymer obtained from at least two different ethylenically unsaturated monomers, and wherein the polymer (P) comprises at least two kinds of side chains (S1) and (S2), which are different from each other, wherein side chain (S1) comprises at least one functional group selected from the group consisting of hydroxyl groups and carboxylic acid groups and mixtures thereof, and side chain (S2) comprises at least one sulfur-containing moiety, which is selected from the group consisting of thiol groups, thioether groups, thioester groups, thiocarboxylic acid groups and mixtures thereof.

2. The method according to claim 1, wherein the acidic aqueous composition (A) is free of any chromium ions.

3. The method according to claim 1, wherein the at least one side chain (S2) additionally contains at least one functional group selected from the group consisting of OH-groups, COOH-groups, and primary and secondary amino groups.

4. The method according to claim 1, wherein polymer (P) contains
monomeric units (s1) present in the polymer, which each contain a side chain (S1) comprising at least one functional group selected from the group consisting of hydroxyl groups and carboxylic acid groups and mixtures thereof in an amount of 50 to 99 mol-%, and
monomeric units (s2) present in the polymer being different from monomeric units (s1), which each contain a side chain (S2) comprising at least one sulfur-containing moiety in an amount of 1 to 50 mol-%,
in each case based on the total amount of all monomeric units of polymer (P), wherein the sum of all monomeric units present in polymer (P) adds up to 100 mol-%.

5. The method according to claim 1, wherein the at least one polymer (P) has a number average molecular weight in the range of from 1 000 to 50 000 g/mol.

6. The method according to claim 1, wherein polymer (P) is present in composition (A) in an amount in the range of from 20 to 1000 ppm.

7. The method according to claim 1, wherein the at least one metal ion (a) is incorporated into composition (A) in form of its complex fluoride.

8. The method according to claim 1, wherein the at least one metal ion selected from the group consisting of titanium, zirconium, hafnium ions and mixtures thereof, is present in composition (A) in an amount in a range of from 5 to 5000 ppm, in each case calculated as metal.

9. The method according to claim 1, wherein the acidic aqueous composition (A) contains free fluoride ions in an amount in the range of from 1 to 500 ppm.

10. The method according to claim 1, wherein the acidic aqueous composition (A) has a pH value in the range of from 0.1 to 6.0.

11. The method according to claim 1, wherein composition (A) comprises molybdenum cations, calculated in each case as metal.

12. An acidic aqueous composition (A) as defined in claim 1.

13. A master batch to produce the acidic aqueous composition (A) according to claim 12, wherein the acidic aqueous composition (A) is produced by diluting the master batch with water and optionally adjusting the pH value.

14. A method of using the acidic aqueous composition (A) according to claim 12, the method comprising using the acidic aqueous composition (A) for treating at least one surface of a substrate, wherein said surface is at least partially made of at least one metal.

15. A substrate comprising at least one surface, wherein said surface is at least partially made of at least one metal, wherein said at least one surface has been treated according to claim 1.

16. The method according to claim 1, wherein the at least one side chain (S2) additionally contains at least one functional group selected from the group consisting of OH-groups, COOH-groups, and NH₂-groups.

17. The method according to claim 1, wherein polymer (P) contains
monomeric units (s1) present in the polymer, which each contain a side chain (S1) comprising at least one functional group selected from the group consisting of hydroxyl groups and carboxylic acid groups and mixtures thereof in an amount of 55 to 95 mol-%, and
monomeric units (s2) present in the polymer being different from monomeric units (s1), which each contain a side chain (S2) comprising at least one sulfur-containing moiety in an amount of 5 to 45 mol-%,
in each case based on the total amount of all monomeric units of polymer (P), wherein the sum of all monomeric units present in polymer (P) adds up to 100 mol-%.

18. The method according to claim 1, wherein polymer (P) contains
monomeric units (s1) present in the polymer, which each contain a side chain (S1) comprising at least one functional group selected from the group consisting of hydroxyl groups and carboxylic acid groups and mixtures thereof in an amount of 60 to 90 mol-%, and
monomeric units (s2) present in the polymer being different from monomeric units (s1), which each contain a side chain (S2) comprising at least one sulfur-containing moiety in an amount of 10 to 40 mol-%,
in each case based on the total amount of all monomeric units of polymer (P), wherein the sum of all monomeric units present in polymer (P) adds up to 100 mol-%.

19. The method according to claim 1, wherein polymer (P) contains
monomeric units (s1) present in the polymer, which each contain a side chain (S1) comprising at least one functional group selected from the group consisting of hydroxyl groups and carboxylic acid groups and mixtures thereof in an amount of 65 to 85 mol-%, and
monomeric units (s2) present in the polymer being different from monomeric units (s1), which each contain a side chain (S2) comprising at least one sulfur-containing moiety in an amount of 15 to 35 mol-%,
in each case based on the total amount of all monomeric units of polymer (P), wherein the sum of all monomeric units present in polymer (P) adds up to 100 mol-%.

20. The method according to claim 1, wherein the at least one polymer (P) has a number average molecular weight in the range of from 1 200 to 40 000 g/mol.
